(19) United States
(12) Patent Application Publication
(10) Pub. No.: US 2024/0396287 A1
(43) Pub. Date: Nov. 28, 2024

(54) PHOTONIC CHIP ABLE TO EMIT AT LEAST ONE OUTPUT LIGHT EMISSION, AND OPTICAL COMPONENT EMPLOYING SUCH A CHIP

(71) Applicant: Scintil Photonics, Grenoble Cedex 9 (FR)

(72) Inventors: Sylvie Menezo, Grenoble Cedex 9 (FR); Torrey Thiessen, Toronto (CA); Jason Chi Chun Mak, Grenoble Cedex 9 (FR)

(21) Appl. No.: 18/693,407

(22) PCT Filed: Sep. 1, 2022
(86) PCT No.: PCT/EP2022/074313

§ 371 Date: Mar. 19, 2024

(30) Foreign Application Priority Data
Sep. 21, 2021 (FR) FR2109956

(51) Int. Cl. H01S 3/23; H01S 3/00; H01S 3/10; H01S 3/13

(52) U.S. Cl. CPC H01S 3/23; H01S 3/0014; H01S 3/10053; H01S 3/1305

(57) ABSTRACT

An integrated photonic chip (PIC) for generating at least one combined light emission includes a bank of lasers having different wavelengths, the bank including at least two lasers emitting a first light emission and a second light emission. The integrated photonic chip further includes at least two active combining devices that are optically associated with the bank of lasers and configured to produce, on at least one optical output, the combined light emission (l1+l′1, l2+l′2; l1+l2, l′1+l′2) combining the light emissions received on its optical inputs. An optical component includes such a photonic chip.

### CROSS REFERENCE TO RELATED APPLICATIONS

This application is a national phase entry under 35 U.S.C. § 371 of International Patent Application PCT/EP2022/074313, filed Sep. 1, 2022, designating the United States of America and published as International Patent Publication WO 2023/046434 A1 on Mar. 30, 2023, which claims the benefit under Article 8 of the Patent Cooperation Treaty to French Patent Application Serial No. FR2109956, filed Sep. 22, 2021.

### TECHNICAL FIELD

The present disclosure relates to a photonic chip, which finds particular application in the field of communications using wavelength division multiplexing. It also relates to an optical component employing such a chip.

### BACKGROUND

The needs for communication between the computing and storage resources of a data center are increasing, and require the implementation of communication channels used in wavelength division multiplexing (WDM) that handle high bit rates, which can be up to 400 Gbit/s or even 800 Gbit/s.

Some solutions allowing this need to be addressed implement high-power WDM sources. In the document “WDM Source Based on High-Power, Efficient 1280-nm DFB Lasers for Terabit Interconnect Technologies,” B. Buckley, IEEE PHOTONICS TECHNOLOGY LETTERS, VOL. 30, NO. 22, Nov. 15, 2018, such a source comprises a bank of distributed feedback lasers, comprising a Bragg grating distributed along the laser cavity. The lasers emit light emissions at stepped wavelengths, typically separated from one another by 100 GHz.

Each laser is formed of an optical cavity defined between two facets, one of the facets being substantially transparent and covered with an antireflective coating, the other being essentially reflective. The light emissions emitted by the lasers on the side of their substantially transparent facet are propagated to the input ports of a passive optical mixer. This mixer produces, on its output ports, a plurality of light emissions each combining the light emissions provided on the input ports. The output emissions produced on these output ports are therefore multi-wavelength (in a spectral comb, each line of the comb corresponding to the emission emitted by a laser of the bank). They are then coupled to optical fibers via a fiber grating.

The manufacture of such lasers is delicate, since this manufacturing requires forming the reflective facet of the optical cavity with high precision. Indeed, it is necessary to position the reflective facet very precisely with respect to the feedback Bragg grating of the laser, to within 50 nm, or even to within 20 nm, which cannot be obtained systematically by the laser cleaving techniques commonly used. The efficiency of this manufacturing method is therefore relatively low, on the order of 50%, which leads to the formation of non-functional lasers. This low efficiency is all the more problematic as it applies to each laser of the bank of lasers and, consequently, the manufacturing efficiency of this bank, when it contains N lasers, corresponds to the manufacturing efficiency of one laser raised to the power of N, which may be particularly low for high values of N (typically 8 or above).

It is also known that the wavelengths of the light emissions emitted by the distributed feedback lasers with such a reflective facet are poorly controlled because of the inaccurate positioning of this reflective facet. This results in variability in the spacing present between the spectral lines of the output emissions, whereas it is generally desirable for this spacing to be constant, for example, 100 GHz.

Finally, the significant losses (in particular, the insertion losses) of the passive optical mixer used to form the output light emissions affect the available power in the optical fibers to which the mixer is coupled. The aforementioned document thus provides the formation of lasers having respective powers of several hundred mW so that each output emission has a power of 10 mW. These losses tend to grow with the number of input/output ports of the optical mixer, which is problematic when the number of lasers in the bank is high. In such a mixer, the number of input ports and output ports is necessarily the same in order to exploit all of the power of the input emissions. The solution proposed in the aforementioned document therefore requires that the number of optical fibers is equal to the number of lasers of the bank, which can be restrictive in certain applications.

### BRIEF SUMMARY

An object of the present disclosure is to propose a solution to at least some of these problems.

With a view to achieving this object, the present disclosure proposes an integrated photonic chip for generating at least one combined light emission, the integrated photonic chip comprising:
a bank including at least two lasers having different wavelengths, each laser comprising an optical cavity defined by two ends and emitting a first light emission and a second light emission respectively issuing from the two ends;
at least two active combining devices that are optically associated with the bank of lasers, each active combining device having at least a first and a second optical input for receiving some of the first and second light emissions and being configured to produce, on at least one optical output, a combined light emission combining the light emissions received on its optical inputs, the active combining device further comprising control and measurement elements for controlling the combined light emission produced on the optical output, the control and measurement elements comprising at least one pilot-controllable phase shifter and a photodetector;
a waveguide grating for directly propagating the first and second light emissions between the bank of lasers and the active combining devices.

According to other advantageous non-limiting features of the present disclosure, taken alone or according to any technically feasible combination:
the two lasers are phase-shifted lasers, the ends of which are separated by a feedback grating;
the optical cavity of each phase-shifted laser is equipped with a grating inducing a quarter-wave shift in the cavity;
the lasers of the bank of lasers are assembled with a first part, which at least partially comprises the waveguide grating;
the integrated photonic chip comprises at least one zone for the emission of at least one output light emission, the waveguide grating also propagating the combined light emissions between the active combining devices and the at least one emission zone of the chip;
each active combining device is associated with a phase-shifted laser of the bank of lasers, the first emission and the second emission of the phase-shifted lasers being respectively guided toward the first optical inputs and the second optical inputs of the active combining devices, it being possible for the control and measurement elements to be used such that each active combining device coherently combines the first emission and the second emission;
the active combining devices perform a coherent combination and comprise:
   a combiner having two inputs respectively coupled to the first optical input and to the second optical input, and two outputs, a first of which is coupled to the optical output;
   the control elements comprise at least one pilot-controllable phase shifter arranged optically upstream of at least one of the inputs of the combiner;
   the measurement elements comprise a photodetector arranged optically downstream of the second output of the combiner;
each active combining device is associated with two phase-shifted lasers of the bank of lasers, an emission of one of the two phase-shifted lasers being guided toward the first optical input and an emission of the other of the two phase-shifted lasers being guided toward the second optical input, it being possible for the control and measurement elements to be used such that each active combining device spectrally combines the emissions issuing from the two lasers;
the active combining devices perform a spectral combination and comprise:
   a first and a second combiner, the first combiner having two inputs respectively coupled to the first optical input and to the second optical input, and the second combiner having two outputs, a first of which is coupled the optical output, the two combiners being optically coupled to one another by two arms;
   a delay line arranged in one of the two arms;
   the control elements comprise at least one pilot-controllable phase shifter arranged optically upstream of the second combiner;
   the measurement elements comprise a photodetector arranged optically downstream of the second output of the second combiner;
an active combining device of a first photonic block is arranged on a first side of the bank of lasers and an active combining device of a second photonic block is arranged on a second side of the bank of lasers, opposite the first side;
the bank of lasers comprises 2\hat{ }n phase-shifted lasers associated with at least 2\hat{ }n active combining devices forming a first combination stage and n being an integer greater than 1, the integrated photonic chip comprising at least a second combination stage arranged downstream of the first combination stage, the second combination stage being formed of at least one secondary combining device;
the number of output light emissions is less than or equal to the number of phase-shifted lasers;
the at least one secondary combining device is selected from the list formed of: an active coherent combining device, an active spectral combining device, a passive power divider;
the waveguide grating is associated with at least one coupler, for example, an edge coupler, arranged at the emission zone of the output emission;
the phase-shifted lasers have stepped emission wavelengths.

According to another aspect, the object of the present disclosure proposes an optical component comprising an integrated photonic chip as disclosed above and an integrated control circuit electrically connected to the control and measurement elements of the active combining devices, the integrated control circuit being configured to control the output light emission produced on the optical outputs of the active combining devices.

### BRIEF DESCRIPTION OF THE DRAWINGS

Other features and advantages of the present disclosure will emerge from the following detailed description of example embodiments of the disclosure with reference to the accompanying figures, in which:

FIG. 1 is a block diagram of a first embodiment;

FIG. 2 is a block diagram of the active combining device of FIG. 1;

FIG. 3 shows an example of an integrated photonic chip and of a photonic component according to the first embodiment;

FIG. 4 is a block diagram of a second embodiment;

FIGS. 5A and 5B are block diagrams of the active combining device of FIG. 4;

FIG. 6 shows a second example of an integrated photonic chip according to the second embodiment; and

FIGS. 7-9 show a third example, a fourth example, and a fifth example of an integrated photonic chip hybridizing the first and the second embodiment.

### DETAILED DESCRIPTION

The various embodiments and examples that are the subject matter of the following description use a bank of phase-shifted lasers. In a bank of lasers, the lasers generally have different wavelengths, for example, stepped wavelengths uniformly distributed in a determined frequency band. In the applied example of communication using wavelength division (WDM) presented in the introduction of this disclosure, it is possible, for example, to provide, in the various embodiments and examples of the present description, a bank formed of 8 or 16 phase-shifted lasers, the light emissions of which have frequencies separated from one another by 50 GHz, 100 GHz, 200 GHz, or 400 GHz.

The lasers that make up the bank of lasers are advantageously so-called “phase-shift” lasers. These are distributed feedback lasers, that is, a laser using a Bragg grating to choose the wavelength of the emitted light emission. This feedback grating is distributed along the optical cavity and this cavity has two ends defined by the extent of the grating. According to the present disclosure, each phase-shifted laser therefore emits a first light emission and a second light emission respectively issuing from the two ends of the optical cavity. The optical cavity of each laser is equipped with a grating inducing a quarter-wave shift, generally inserted in the middle of the cavity, so as to ensure that this laser emits only over a single wavelength.

The integrated photonic chip is obtained by assembling the lasers of the bank of lasers with a first part of the chip, this first part having been processed in advance to form therein at least the waveguide grating of the chip. This assembly can be carried out, for example, by molecular adhesion. Such an approach is, in particular, described in the document T. Thiessen et al, “Back-Side-on-BOX Heterogeneous Integrated III-V-on-Silicon O-Band Distributed Feedback Lasers,” in Journal of Lightwave Technology, vol. 38, no. 11, pp. 3000-3006, 2020. This approach makes it possible to form the lasers of the bank and to couple their emissions to the waveguide grating of the chip without having to first form facets by cleaving of the material forming the optical cavity.

A phase-shifted laser has the advantage of providing a light emission with a wavelength that is very well controlled. Its manufacture, in particular, when it implements the assembly technique presented above, is also relatively easy, and does not suffer from the efficiency limitations of distributed feedback lasers, one of the facets of which is equipped with a reflective coating, as was presented in the introduction of this disclosure. However, such a laser configuration emits two light emissions, an emission at each of the ends of the optical cavity, and the optical power of each of these emissions is reduced (two times less than the optical power of the single emission produced by a distributed feedback laser having a reflective facet).

The various embodiments that will be presented remedy this situation by proposing different architectures of integrated photonic chips for the purpose of combining together the emissions issuing from the bank of lasers. It is thus possible to couple an integrated photonic chip having N phase-shifted lasers (producing 2N light emissions) to M optical fibers, with M being less than or equal to N. Each optical fiber receives a combined light emission from the chip, which has improved power.

It should be noted that the use of a passive mixer associated with a photonic chip comprising a bank of N lasers of power P and producing 2N light emissions of power P/2 would have led to supplying, at the output of this mixer, 2N combined light emissions each having a power of P/4N (a 2N*2N mixer inducing losses of the order of ½N.) Such a power level cannot be sufficient, in particular, when this number N is relatively large.

In a chip equipped with a plurality of lasers, it is advantageous for optical routing reasons to arrange the phase-shifted lasers on the chip so as to align their respective ends and thus define a first side of the bank of lasers at which the first light emissions are emitted and a second side of the bank of lasers at which the second light emissions are emitted. The various embodiments repeat this advantageous arrangement but this in no way forms a limitation of the present disclosure. Generally, the lasers forming the bank of lasers can be arranged in any suitable arrangement.

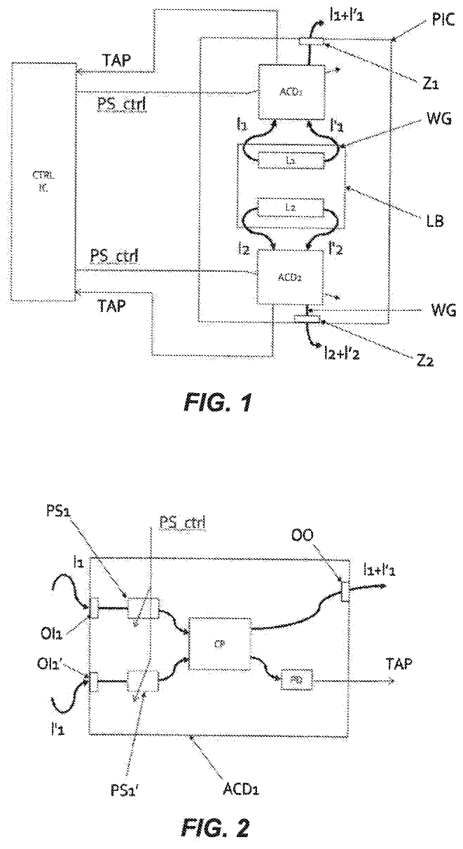

FIG. 1 thus shows a block diagram of a first embodiment of an integrated photonic chip PIC. The chip PIC comprises a bank LB of lasers, here formed of two phase-shifted lasers L1, L2 in order to simplify the description. In this embodiment, the two light emissions emitted by a laser L1, L2 are combined coherently with each other in order to form a combined emission of increased power.

The first phase-shifted laser L1 emits a first emission l1 and a second emission l′1 from each of its ends. Similarly, the second phase-shifted laser L2 emits a first emission l2 and a second emission l′2 from each of its ends. As already mentioned, the emissions produced by the first and the second laser L1, L2 advantageously have different wavelengths.

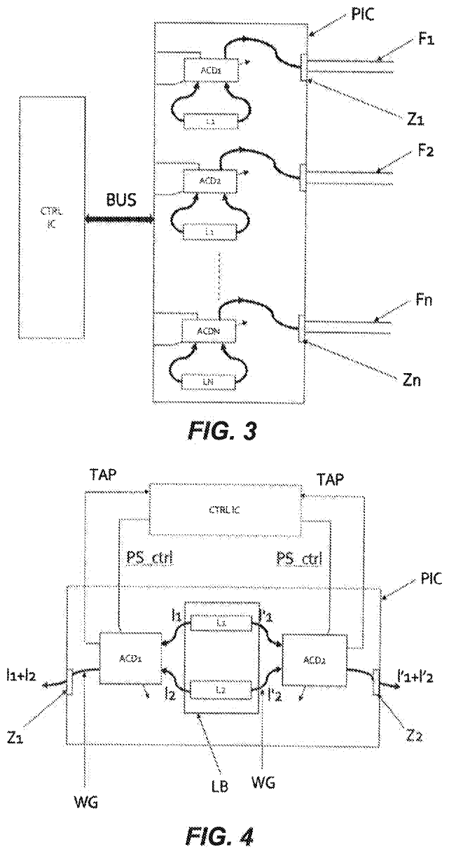

The integrated photonic chip PIC of the block diagram of FIG. 1 comprises two active combining devices ACD1, ACD2, shown in detail in FIG. 2. Each active combining device ACD1, ACD2 is associated with a laser L1, L2 and performs the coherent combination of the first light emissions l1, l2 with the second light emissions l′1, l′2. Thus, two combined light emissions l1+l′1, l2+l′2 are produced by the lasers L1, L2, which are guided to the emission zones Z1, Z2 of the chip, it being possible for these emission zones Z1, Z2 to be formed, for example, by edge couplers.

The integrated photonic chip PIC also comprises a waveguide grating WG for propagating the first and second light emissions between the bank LB of lasers and the active combining devices ACD1, ACD2 and for propagating the combined light emissions between these active combining devices ACD1, ACD2 and the emission zones Z1, Z2 of the chip. Advantageously, the waveguides WG directly propagate the first and second light emissions between the bank LB of lasers and the active combining devices ACD1, ACD2, that is, these emissions are not modified (for example, modulated) during this propagation.

In all the embodiments of the present disclosure, the combining devices ACD1, ACD2 are said to be “active” since they comprise control and measurement elements that make it possible to control the light emissions issuing from the phase-shifted lasers L1, L2 and to combine them in a perfectly controlled manner, in particular, by controlling the phase of these light emissions. The control and measurement elements comprising at least one pilot-controllable phase shifter and a photodetector. Because of the active nature of these devices, the combination can be effected with reduced losses, of the order of 0.5 dB. These control and measurement elements, and, in particular, the pilot-controllable phase-shifter(s) and the photodetector, are electrically connected to electrical contact pads of the integrated photonic chip PIC. An integrated control circuit CTRL_IC can be associated with the integrated photonic chip PIC and be electrically connected to the control and measurement elements of the active combining devices ACD1, ACD2. The integrated control circuit CTRL_IC is configured to calibrate the control elements (the pilot-controllable phase-shifter(s), for example) and regulate the combined light emissions produced on the optical outputs of the active combining devices ACD1, ACD2 so that these emissions conform to a chosen setpoint, in particular, so that all the optical power is transmitted in one of these optical outputs. To this end, the integrated control circuit receives the measurement provided by the photodetector, this measurement allowing the implementation of the optical regulation.

FIG. 2 shows the first active combining device ACD1 of the first embodiment, it being understood that the second active combining device ACD2 has an identical architecture. The first active combining device ACD1 has a first and a second optical input OI1, OI1′ for receiving, respectively, the first and the second light emission l1, l′1 from the first laser L1. It also has an optical output OO on which the combined light emission l1+l′1 is produced, which coherently combines the light emissions received on the optical inputs OI1, OI1′. The combination as such is implemented by a combiner CP, carried out, for example, by a multimode interferometer or by Y-junction waveguides. The combiner CP has two inputs respectively coupled to the first and the second optical input OI1, OI1′ and two outputs, a first of which is coupled to the optical output OO of the active combining device ACD1.

To allow this coherent combination, the first active combining device ACD1 shown in FIG. 2 comprises two pilot-controllable phase shifters PS1, PS1′, arranged optically upstream of the inputs of the combiner CP. They can be thermo-optical phase shifters. The phase delay introduced into an emission by a phase shifter PS1, PS1′ is controllable by the electrical signal PS_ctrl produced by the control device CTRL_IC. Generally, an active combining device ACD1 of this first embodiment comprises at least one pilot-controllable phase shifter, this being sufficient to allow the coherent combination but may require a significant amount of energy to achieve the conditions allowing this combination. This is why, advantageously, it is provided to equip the active combining device with two pilot-controllable phase shifters.

The first active combining device ACD1 shown in FIG. 2 also comprises a photodetector PD optically downstream of the second output of the combiner CP. This photodetector produces an electrical signal TAP, supplied to the control device CTRL IC.

During operation, the control device CTRL_IC adjusts, using the control signals PS_ctrl, the phases introduced by the phase shifters PS1, PS1′ so that a maximum of the optical power of the signals is combined in the output of the combiner CP, which propagates toward the optical output OO. To do this, the control device CTRL_IC measures the optical power available on the other channel of the combiner using the measurement signal supplied by the photodetector PD, which it seeks to minimize. In other words, the control device CTRL_IC implements a regulation for the purpose of minimizing the measurement signal TAP supplied by the photodetector PD by adjusting the phase of the first and second emission l1, l′1 before combining them using the combiner CP.

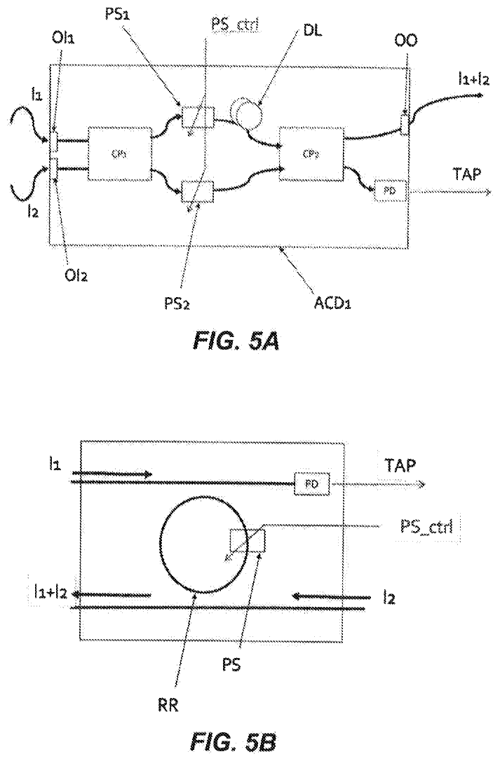

FIG. 3 shows a first example of an integrated photonic chip PIC and an optical component according to this first embodiment of the present disclosure. The control device CTRL_IC electrically connected to the integrated photonic chip PIC using a bus BUS grouping together all the control and measurement signals PS_ctrl, TAP intended to control the active combining devices ACD1-ACDN of the chip PIC is found here again.

In this example, the integrated photonic chip PIC comprises a number N of phase-shifted lasers, for example, 8, 16, or more. Each phase-shifted laser L1-LN is associated with an active combining device ACD1-ACDN, this device coherently combining the two light emissions supplied by each of the ends of the optical cavity forming the laser.

The combined light emissions are guided, in this example, toward the emission zones Z1-ZN, where they are coupled to a grating of N optical fibers F1-FN. These emission zones Z1-ZN can comprise coupling means, for example, edge couplers or surface coupling gratings, to facilitate the injection of the combined emissions into the fibers F1-FN. It is of course possible to provide other optical elements on the combined emission propagation path, in the integrated photonic chip or outside the latter in order to perform any desired transformation to the combined light emissions.

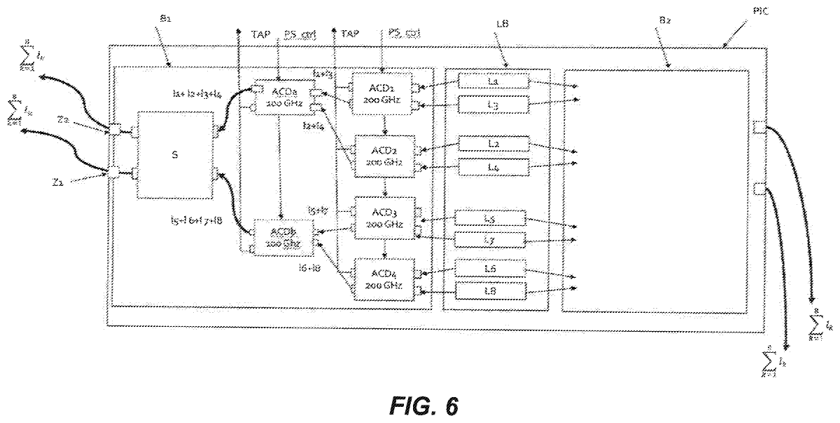

FIG. 4 shows a block diagram of a second embodiment of an integrated photonic chip PIC according to the present disclosure.

The chip PIC of the block diagram of FIG. 4 comprises a bank LB of lasers formed from two phase-shifted lasers L1, L2 in order to simplify the description. The bank LB of lasers has all the features of the bank presented in the initial portion of this detailed description. The two phase-shifted lasers L1, L2 emit, in particular, first light emissions l1, l′1 and second light emissions l2, l′2 having different wavelengths. In this embodiment, the light emissions emitted by two phase-shifted lasers L1, L2 are spectrally combined in order to form a combined multispectral emission of increased power.

Thus, and as can be seen very clearly in FIG. 4, the first light emission l1 emitted by the first phase-shifted laser L1 and the first light emission l2 emitted by the second phase-shifted laser L2 are both guided onto the optical inputs OI1, OI2 of a first active combining device ACD1, thus effecting, in this embodiment, a spectral combination of the two first emissions l1, l2 in order to form a first combined emission l1+l2. Similarly, the second light emission l′1 emitted by the first phase-shifted laser L1 and the second light emission l′2 emitted by the second phase-shifted laser L2 are both guided onto the optical inputs OI1, OI2 of a second active combining device ACD2 in order to form a combined emission l′1+l′2. The active combining devices ACD1, ACD2 therefore constitute multiplexers or interleavers.

As in the first embodiment, the integrated photonic chip PIC of this second embodiment comprises a waveguide grating WG for propagating the first and second light emissions between the bank LB of lasers and the active combining devices ACD1, ACD2 and for propagating the combined light emissions between the active combining devices ACD1, ACD2 and the emission zones Z1, Z2 of the chip. It is of course possible, as in the first embodiment, to provide other optical elements on the combined emission propagation path, in the integrated photonic chip PIC or outside the latter in order to perform any desired transformation to the combined light emissions.

The integrated photonic chip PIC is also associable with a control integrated circuit CTRL_IC, electrically connected to the control elements of the active combining devices ACD1, ACD2, and similar to that presented in the first embodiment. The integrated control circuit CTRL_IC is thus configured to control the operation of the active combining devices ACD1, ACD2 so that they perform the desired spectral combination. To this end, it receives the measurement signals TAP from the active combining devices ACD1, ACD2 and produces the control signals PS_ctrl intended for these devices.

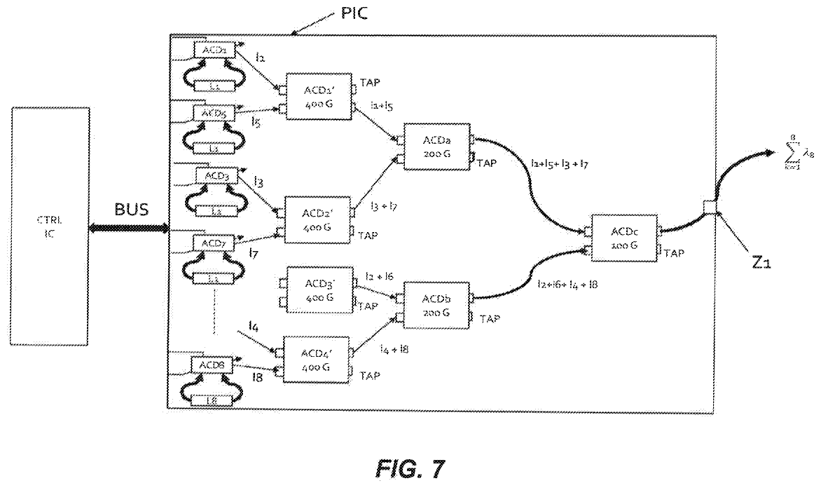

FIG. 5A is a block diagram of the first active combining device ACD of FIG. 4, it being understood that the second active combining device ACD2 has an identical architecture. In general, this active combining device ACD of the second embodiment can be a Mach-Zehnder interferometer. More precisely, this first active combining device ACD1 has a first and a second optical input OI1, OI2 for receiving, respectively, the first light emissions l1, l2 of the two lasers L1, L2. It also has an optical output OO on which is produced the combined light emission l1+l2 spectrally combining the light emissions received on the optical inputs OI1, OI2. The combination as such is implemented by two combiners CP1, CP2, formed, for example, by multimode interferometers or by Y-junction waveguides. The first combiner CP1 has two inputs respectively coupled to the first and the second optical input OI1, OI2 and two outputs respectively coupled to the two inputs of the second combiner CP2. This second combiner CP2 itself has two outputs, a first of which is coupled to the optical output OO of the active combining device ACD1.

To allow the spectral combination without significant optical losses, the first active combining device ACD1 shown in FIG. 5A comprises two pilot-controllable phase shifters PS1, PS2, arranged optically between the two combiners CP1, CP2. As in the first embodiment, it could be provided to equip the device with a single pilot-controllable phase shifter. The phase deviation introduced into the light emissions by the phase shifters PS1, PS2 is controllable by the control electrical signals PS_ctrl produced by the control device CTRL IC. One of the two arms connecting the combiners CP1, CP2 is equipped with an additional waveguide portion DL, forming a delay line. As is well known, the length of the additional waveguide portion DL determines the transmission function of the active combining device, that is, the spectral deviation that the first light emissions must have at the input of the device in order to allow them to be combined at the output. The detailed description of this device is, in particular, available in the document “Wavelength Filters for Fibre Optics,” ed. by H. Venghaus, Springer Series in Optical Sciences, Vol. 123, Springer, pp. 381-432.

The first active combining device ACD1 shown in FIG. 5A also comprises a photodetector PD optically downstream of the second output of the second combiner CP2. This photodetector produces an electrical measurement signal TAP, supplied to the control device CTRL_IC.

During operation, the control device CTRL_IC adjusts, using the control signals PS_ctrl, the phases introduced by the phase shifters PS1, PS2 so that a maximum of the optical power of the emissions is combined in the output of the coupler, which propagates toward the optical output OO. To do this, the control device CTRL_IC measures the optical power available on the other channel of the coupler using the measurement signal supplied by the photodetector PD, which it therefore seeks to minimize.

FIG. 5B shows an alternative block diagram to that shown in FIG. 5A, wherein the first active combining device ACD is this time implemented by a resonant ring. A resonant ring RR is arranged between two arms arranged between the optical inputs and the optical outputs of the active combining device ACD. A phase shifter PS is arranged on the resonant ring RR. One of the outputs is also equipped with a photodetector PD.

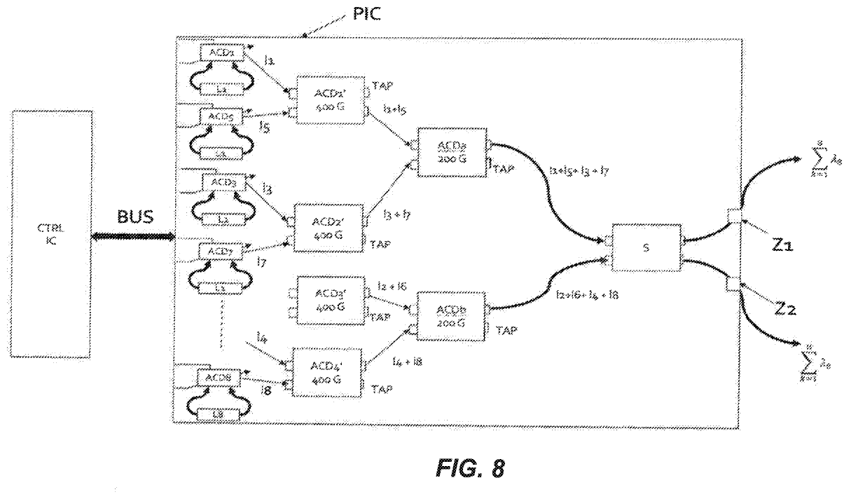

FIG. 6 shows a second example of an integrated photonic chip PIC in accordance with the second embodiment of the present disclosure. For the sake of readability of the figure, it has been omitted to show the control device CTRL IC, but such a device can be provided, electrically connected to the integrated photonic chip PIC as was presented in example 1 of FIG. 3, in order to form a functional optical component.

The bank LB of lasers is arranged centrally in the integrated photonic chip PIC, between a first photonic block B1 and a second photonic block B2. These two blocks B1, B2 have an identical composition in this example so that only the architecture of the first block B1 is shown in detail. It is naturally not necessary for these two blocks, generally, to be completely identical. Each block combines between them the emissions issuing from the 8 phase-shifted lasers by implementing the principles of the second embodiment in order to provide at two emission zones Z1, Z2 two output light emissions spectrally combining the light emissions of the phase-shifted lasers of the bank LB of lasers.

The phase-shifted lasers L1-L8 of the bank LB of lasers have stepped wavelengths, two lasers with successive indexes Li, Li+1 being separated by a 100 GHz spectral separation band in this example. Of course, the value of this spectral separation band according to the field of application, the spectral bandwidth available to accommodate all the emissions, and the number of phase-shifted lasers in the bank LB of lasers can be freely chosen.

Continuing the description of FIG. 6, and of the first photonic block B1, the latter comprises four active combining devices ACD1-ACD4, respectively associated with two first light emissions of two different phase-shifted lasers. Four combined light emissions are thus formed, these combined light emissions therefore each having two spectral lines corresponding to the emission wavelength of each of the original phase-shifted lasers. These four active combining devices ACD1-ACD4 are similar and form a first combination stage of the first block.

In the example of FIG. 6, a second combination stage is provided, composed of two active secondary combining devices ACDa-ACDb. The combined light emissions are guided in pairs onto the inputs of these two devices, which combine these emissions in pairs in order to supply in turn two combined light emissions therefore each having four spectral lines corresponding to the emission wavelength of each of the original phase-shifted lasers. More precisely, a first secondary device ACDa supplies a light emission l1+l2+l3+l4 having the spectral content of the first 4 lasers L1-L4 to which it is optically coupled. Similarly, a second secondary device ACDb supplies a light emission l5+l6+l7+l8 having the spectral content of the other 4 lasers L5-L8 of the bank to which it is optically coupled. In order to facilitate this two-stage combination, it should be noted that the phase-shifted lasers L1-LN are associated with the active combining devices of the first stage in an interleaved manner: two phase-shifted lasers associated with a same active combining device being shifted by 200 GHz. It is thus ensured that the spectral combinations of the second stage of the first block B1 are carried out on two light emissions with spectral lines, which are separated from one another by 100 GHz.

Finally, the first photonic block of the example of FIG. 6 comprises in a third stage a power divider S, which constitutes a device for passively combining the combined light emissions issuing from the second stage. This passive combining device constitutes a third combination stage. Such a passive device has a relatively significant optical loss, of the order of 3.5 dB, but makes it possible to easily (without active control means) combine the two combined light emissions issuing from the second stage of the first photonic block B1. This first block ultimately produces, at the two emission zones Z1, Z2, two output emissions spectrally combining the emissions issuing from the eight phase-shifted lasers L1-L8 of the bank LB of lasers. It will be understood that each output light emission, issuing from multiple combinations, has a relatively high power. As already stated, the second photonic block B2 of the integrated photonic chip can have an architecture identical to that of the first photonic block B1, so that ultimately the integrated photonic chip PIC produces four output light emissions, which can be coupled to a grating of four optical fibers, not shown in the figure.

More generally, it is understood that each photonic block B1, B2 can comprise a plurality of combination stages, each stage being composed of at least one active or passive combining device. The combining devices present in the stages of an order greater than or equal to 2 are referred to as secondary combining devices in the present disclosure. It is thus possible to form a particularly effective photonic chip (by favoring the active combining devices) and to limit the number of output ports of the chip, that is to say for output light emissions, independently of the number of phase-shifted lasers, each output light emission having a relatively high optical power. It is therefore possible to propose an integrated photonic chip having N phase-shifted lasers, each producing two output light beams, and to effectively couple this chip PIC to a number M of optical fibers, M being less than N (in the case of a plurality of combination stages) or equal to N (in the case of a chip PIC having a single combination stage).

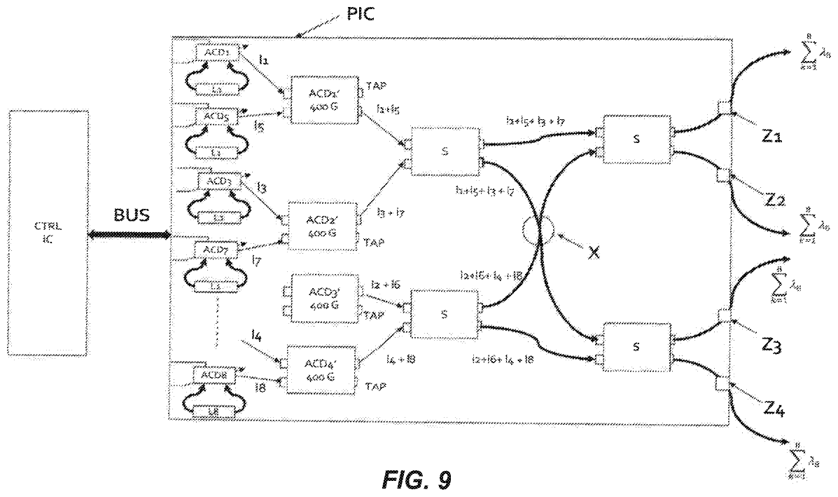

FIG. 7 shows a third example of an integrated photonic chip PIC hybridizing the first and the second embodiment. For the sake of simplifying the figure, the control and measurement elements as well as the associated signals have not been shown therein, for all the active combining devices. However, they are of course present.

In this example, eight phase-shifted lasers L1-L8 are associated with a first combination stage formed of eight active combining devices ACD1-ACD8 in accordance with the first embodiment. Each active combining device therefore implements a coherent combination of the 2 emissions issuing from the phase-shifted laser with which it is associated.

This first stage is optically connected by a waveguide grating to three other successive stages of secondary active combining devices, in accordance with the second embodiment, that is, performing a spectral combination. The second stage is composed of four secondary active combining devices ACD1′-ACD4′, the third combination stage is composed of two secondary active combining devices ACDa, ACDb, and the fourth stage of a single secondary active combining device ACDc.

The integrated photonic chip of this third example uses only active combining devices, which tends to reduce the optical losses (at the cost of a slightly higher degree of regulating complexity). All the optical power generated by the bank of lasers, except for the losses, is made available in a single output emission of the chip PIC, at a single emission zone Z1. This output emission carries the spectral content of the 8 phase-shifted lasers LS1-LS8 of the bank LB.

FIG. 8 shows a fourth example of an integrated photonic chip PIC hybridizing the first and the second embodiment. This is a variation of the photonic chip of the third example of FIG. 7, wherein the secondary active combining device of the fourth stage has been replaced by a passive combining device S. It can be a power divider. The optical power generated by the bank of lasers is made available in two output emissions of the chip PIC, at the two emission zones Z1, Z2.

FIG. 9 shows a fifth example of a photonic integrated chip PIC hybridizing the first and the second embodiment. This is a variation of the photonic chips PIC of the third example and of the fourth example of FIGS. 7 and 8, wherein the secondary active combining devices ACDa, ACDb, ACDc of the fourth and of the third stage have been replaced by passive combining devices S, such as power dividers. The optical power generated by the bank of lasers is made available in four output emissions of the chip PIC, at the four emission zones Z1-Z4. It will be noted that this architecture requires the crossing of two waveguides at the zone marked X in this figure, this crossing causing losses of the order of 0.5 dB.

Naturally, the present disclosure is not limited to the embodiments described, and it is possible to add alternative embodiments without departing from the scope of the invention as defined by the claims.

Although the use of a bank of distributed feedback phase-shifted lasers, which forms the type of laser preferred in numerous applications for the advantages mentioned in a previous paragraph of this disclosure, has been shown, the present disclosure is, however, in no way limited to this type of laser. It applies more generally to any bank formed by lasers each comprising an optical cavity defined by two ends and emitting a first light emission and a second light emission respectively issuing from the two ends.

In order to reduce the number of contact pads on the integrated photonic chip PIC and facilitate the routing of the measurement signals, it can be provided to connect together all the conductive lines carrying the measurement signals TAP of the active combining devices ACD1-ACDN. A single electrical measurement signal is thus made available at a single pad of the chip PIC, this measurement signal being representative of the optical power available on all the photodetectors of the active combining devices of the chip PIC. A single line of the bus BUS carries this measurement signal in order to transmit it to a single input of the control device CTRL IC. The latter implements a program for calibrating and/or regulating the control signals PS_ctrl of the phase shifters of each active combining device ACD1-ACDN. The purpose of this calibration and/or regulation program is to minimize the value carried by the single measurement signal, for example, during a start-up phase of the chip.

As an alternative to such a program, it can be provided to equip the integrated photonic chip with a multi-way switch, controllable by the control device CTRL_IC, making it possible to connect the photodetector of a selected active combining device to the single contact pad of the integrated photonic chip.

Moreover, although it has been described and shown in the various embodiments and in the examples that the combined emissions were guided directly toward the emission zones of the integrated photonic chip, this feature is, however, not essential. It is thus possible to provide that other devices intercepting the propagation of these combined light emissions are inserted, for example, a modulator grating, before they are conveyed by the waveguide grating toward the emission zone(s) of the chip.

Even more generally, it is not necessary for the integrated photonic chip to have emission zones: it can constitute an integrated communication device, for example, between a computing device and a memory device, making it possible to communicate data between these two devices without it being necessary to couple the chip to optical fibers or propagate output emissions by free propagation. In this case, it then comprises, in addition to the described means for preparing a combined emission, means for modulating and receiving this emission. Thus, and generally, the object of the present disclosure is to generate at least one combined emission from the bank of lasers. This laser may be of the DFB, DBR (distributed Bragg reflector laser), or DML (discrete mode laser) type.

1. An integrated photonic chip (PIC) for generating at least one combined light emission, the integrated photonic chip comprising:
a bank including at least two lasers having different wavelengths, each of the at least two lasers comprising an optical cavity defined by two ends and emitting configured to emit a first light emission and a second light emission respectively issuing from the two ends;
at least two active combining devices optically associated with the bank of lasers, each of the at least two active combining devices having at least a first optical input and a second optical input for receiving some of the first light emission and the second light emission and being configured to produce, on at least one optical output, a combined light emission combining light emissions received on the at least a first optical input and the second optical input, the at least two active combining devices further comprising control and measurement elements to control the combined light emission produced on the optical output; and
a waveguide grating for directly propagating the first and second light emissions between the bank of lasers and the at least two active combining devices.

2. The integrated photonic chip (PIC) of claim 1, wherein the at least two lasers are phase-shifted lasers, the ends of the phase-shifted lasers being separated by a feedback grating.

3. The integrated photonic chip (PIC) of claim 2, wherein the optical cavity of each of the phase-shifted lasers is equipped with a grating configured to induce a quarter-wave shift in the cavity.

4. The integrated photonic chip (PIC) of claim 1, wherein the at least two lasers of the bank are assembled with a first part that comprises at least a portion of the waveguide grating.

5. The integrated photonic chip (PIC) of claim 1, further comprising at least one emission zone of at least one output light emission, the waveguide grating also propagating combined light emissions between the at least two active combining devices and the at least one emission zone.

6. The integrated photonic chip of claim 1, wherein each of the at least two active combining devices is associated with a phase-shifted laser of the bank, a first emission and a second emission of the phase-shifted lasers being respectively guided toward the first optical inputs and the second optical inputs of the at least two active combining devices, the control and measurement elements being capable of being used such that each of the at least two active combining devices coherently combines the first emission and the second emission.

7. The integrated photonic chip (PIC) of claim 6, wherein the at least two active combining devices perform a coherent combination and comprise:
a combiner having two inputs respectively coupled to the first optical input and to the second optical input, and two outputs, a first of which is coupled to the optical output;
wherein the control elements comprise at least one pilot-controllable phase shifter arranged optically upstream of at least one of the inputs of the combiner; and
wherein the measurement elements comprise a photodetector arranged optically downstream of the second output of the combiner.

8. The integrated photonic chip (PIC) of claim 1, wherein each of the at least two active combining devices is associated with two phase-shifted lasers of the bank, an emission of one of the two phase-shifted lasers being guided toward the first optical input and an emission of the other of the two phase-shifted lasers being guided toward the second optical input, the control and measurement elements being capable of being to be-used such that each active combining device spectrally combines the emissions issuing from the two lasers.

9. The integrated photonic chip (PIC) of claim 8, wherein the at least two active combining devices are configured to perform a spectral combination and comprise:
a first and a second combiner, the first combiner having two inputs respectively coupled to the first optical input and to the second optical input, and the second combiner having two outputs, a first of which is coupled to the optical output, the two combiners being optically coupled to each other by two arms;
a delay line arranged in one of the two arms;
wherein the control elements comprise at least one pilot-controllable phase shifter arranged optically upstream of the second combiner; and
wherein the measurement elements comprise a photodetector arranged optically downstream of the second output of the second combiner.

10. The integrated photonic chip (PIC) of claim 9, wherein an active combining device of a first photonic block is arranged on a first side of the bank and an active combining device of a second photonic block is arranged on a second side of the bank, opposite the first side.

11. The integrated photonic chip (PIC) of claim 1, wherein the bank comprises 2\hat{ }n phase-shifted lasers associated with at least 2\hat{ }n active combining devices forming a first combination stage, and n being an integer greater than 1, the integrated photonic chip further comprising at least a second combination stage arranged downstream of the first combination stage, the second combination stage including at least one secondary combining device.

12. The integrated photonic chip (PIC) of claim 11, wherein the number of output light emissions is less than or equal to the number of phase-shifted lasers.

13. The integrated photonic chip (PIC) of claim 11, wherein the at least one secondary combining device is chosen from among the group consisting of: an active coherent combining device, an active spectral combining device, or a passive power divider.

14. The integrated photonic chip (PIC) of claim 11, wherein the waveguide grating is associated with at least one coupler.

15. The integrated photonic chip (PIC) according to claim 11, wherein the phase-shifted lasers have stepped emission wavelengths.

16. An optical component, comprising:
an integrated photonic chip according to claim 1; and
a control integrated circuit electrically connected to the control and measurement elements of the active combining devices, the integrated control circuit being configured to control the output light emission produced on the optical outputs of the active combining devices.

17. The optical component of claim 16, wherein the at least two lasers of the integrated photonic chip (PIC) are phase-shifted lasers, ends of the phase-shifted lasers being separated by a feedback grating.

18. The optical component of claim 17, wherein the optical cavity of each of the phase-shifted lasers is equipped with a grating configured to induce a quarter-wave shift in the cavity.

19. The optical component of claim 16, wherein the at least two lasers of the bank are assembled with a first part that comprises at least a portion of the waveguide grating.

20. The integrated photonic chip (PIC) of claim 14, wherein the at least one coupler comprises an edge coupler.
